(19) United States
(12) Patent Application Publication
(10) Pub. No.: US 2026/0329850 A1
(43) Pub. Date: Oct. 22, 2026

(54) METHODS FOR CREATIVE IDEATION THROUGH STRUCTURING INSPIRATION

(71) Applicants: Toyota Research Institute, Inc., Los Altos, CA (US); Carnegie Mellon University, Pittsburgh, PA (US)

(72) Inventors: Yaqing Yang, Pittsburgh, PA (US); Vikram Mohanty, Pittsburgh, PA (US); Nikolas Martelaro, Pittsburgh, PA (US); Aniket Kittur, Pittsburgh, PA (US); Yin-Ying Chen, Los Altos, CA (US); Matthew K. Hong, Los Altos, CA (US)

(73) Assignees: Toyota Research Institute, Inc., Los Altos, CA (US); Carnegie Mellon University, Pittsburgh, PA (US); Toyota Jidosha Kabushiki Kaisha, Toyota-shi Aichi-ken (JP)

(21) Appl. No.: 19/304,078

(22) Filed: Aug. 19, 2025

Related U.S. Application Data
(60) Provisional application No. 63/792,080, filed on Apr. 21, 2025.

(51) Int. Cl. G06F 16/242; G06F 16/248

(52) U.S. Cl. CPC G06F 16/2423; G06F 16/248

(57) ABSTRACT

A method may include receiving a query, modifying the query to generate a modified query to be input into a large language model to cause the large language model to output a plurality of solutions associated with the query, inputting the modified query to the large language model, and displaying an output of the large language model in response to the modified query in a hierarchical structure.

### CROSS-REFERENCE TO RELATED APPLICATION

The present specification is based on, and claims the benefit of, U.S. Provisional Application No. 63/792,080, filed Apr. 21, 2025, the disclosure of which is hereby incorporated by reference in its entirety.

### TECHNICAL FIELD

The present specification relates to methods for creative ideation through structuring inspiration.

### BACKGROUND

A key driver in innovative problem solving, such as in design or scientific discovery, is exposure to a broad and diverse set of inspirations that can motivate potential new solutions. These inspirations serve as external stimuli that help in problem formulation, direction definition, and solution generation. Today, people have access to more sources of inspiration than ever before, using online search engines and generative AI to find or create relevant solution mechanisms from nearly any source, such as web pages, videos, patents, or papers. However, finding, making sense of, and using this enormous space of inspiration is limited due to the challenge for users to browse, organize, and select specific ideas. Though stimuli retrieved or generated by computational systems have the potential to spark an a-ha moment during ideation, users may get overwhelmed with this large volume of external information. Accordingly, there is a need for improved methods for creative ideation through structuring inspiration.

### SUMMARY

In one embodiment, a method may include receiving a query, modifying the query to generate a modified query to be input into a large language model to cause the large language model to output a plurality of solutions associated with the query, inputting the modified query to the large language model, and displaying an output of the large language model in response to the modified query in a hierarchical structure.

In another embodiment, a computing device may include one or more processors configured to receive a query, modify the query to generate a modified query to be input into a large language model to cause the large language model to output a plurality of solutions associated with the query, input the modified query to the large language model, and display an output of the large language model in response to the modified query in a hierarchical structure.

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1 schematically depicts an illustrative computing network for implementing a system for creative ideation through structuring inspiration, according to one or more embodiments shown and described herein;

FIG. 2 depicts the server computing device of FIG. 1, according to one or more embodiments shown and described herein;

FIG. 3 depicts an example output that may be generated by the server computing device of FIGS. 1 and 2, according to one or more embodiments shown and described herein;

FIG. 4 depicts another example output that may be generated by the server computing device of FIGS. 1 and 2, according to one or more embodiments shown and described herein;

FIG. 5 depicts a flow diagram of an illustrative method that may be performed by the server computing device of FIGS. 1 and 2, according to one or more embodiments shown and described herein;

FIG. 6 depicts another example output that may be generated by the server computing device of FIGS. 1 and 2, according to one or more embodiments shown and described herein;

FIG. 7 depicts another example output that may be generated by the server computing device of FIGS. 1 and 2, according to one or more embodiments shown and described herein;

FIG. 8 depicts another example output that may be generated by the server computing device of FIGS. 1 and 2, according to one or more embodiments shown and described herein;

FIG. 9 depicts another example output that may be generated by the server computing device of FIGS. 1 and 2, according to one or more embodiments shown and described herein;

FIG. 10A depicts a first portion of another example output that may be generated by the server computing device of FIGS. 1 and 2, according to one or more embodiments shown and described herein;

FIG. 10B depicts a second portion of the example output of FIG. 10A that may be generated by the server computing device of FIGS. 1 and 2, according to one or more embodiments shown and described herein; and

FIG. 10C depicts a third portion of the example output of FIGS. 10A and 10B that may be generated by the server computing device of FIGS. 1 and 2, according to one or more embodiments shown and described herein.

### DETAILED DESCRIPTION

The embodiments disclosed herein are directed to methods for creative ideation through structuring inspiration. In embodiments, ideas are presented to a user such that the user can more efficiently explore the ideas, focusing on areas of potential interest and avoiding areas that may be less relevant or fruitful. The disclosed embodiments also help users notice and transfer the ‘active ingredient’ of an inspiration, which may be from a different domain, to their problem domain. For example, an ultrasonic cleaning system developed for removing contaminants from spacecraft might be useful for a designer interested in reducing the amount of water used in laundry. However, it might be difficult for the user to initially notice the relevance of the idea and to transfer the idea and use it in the laundry domain. Embodiments disclosed herein utilize large language models (LLMs) to generate inspirations at different levels of distance from the original problem domain and examine what kinds of information people use to connect to and use those inspirations.

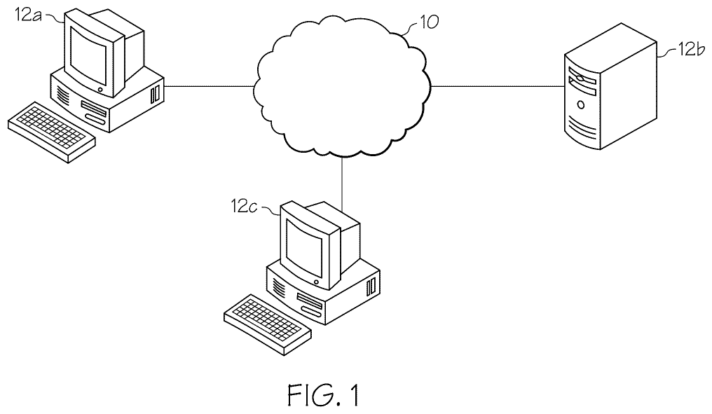

Referring now to the figures, FIG. 1 depicts an illustrative computing network, illustrating components of a creative ideation system for performing the functions described herein, according to embodiments shown and described herein. As illustrated in FIG. 1, a computer network 10 may include a wide area network, such as the internet, a local area network (LAN), a mobile communications network, a public service telephone network (PSTN) and/or other network and may be configured to electronically connect a user computing device 12a, a server computing device 12b, and an administrator computing device 12c.

The user computing device 12a may be used to input information to be utilized to implement the creative ideation system, as disclosed herein. For example, the user computing device 12a may be a personal computer running software that a user utilizes to input queries, as disclosed in further detail below. After this information is input into the user computing device 12a, the user computing device 12a or the server computing device 12b may perform the techniques disclosed herein to implement the creative ideation system. In some examples, the user computing device 12a may be a tablet, a smartphone, a smart watch, or any other type of computing device used by a user to input a document to be analyzed.

The administrator computing device 12c may, among other things, perform administrative functions for the server computing device 12b. In the event that the server computing device 12b requires oversight, updating, or correction, the administrator computing device 12c may be configured to provide the desired oversight, updating, and/or correction. The administrator computing device 12c, as well as any other computing device coupled to the computer network 10, may be used to input historical cost data or historical effect size data into a database.

The server computing device 12b may receive information input into the user computing device 12a by a user, and may perform the techniques disclosed herein to implement the creative ideation system. The server computing device 12b may then transmit generated responses to be displayed by the user computing device 12a based on the operations performed by the server computing device 12b. In some examples, the server computing device 12b may be removed from the system of FIG. 1 and may be replaced by a software application on the user computing device 12a. For example, the functions of the server computing device 12b may be performed by software operating on the user computing device 12a. The components and functionality of the server computing device 12b will be set forth in detail below.

It should be understood that while the user computing device 12a and the administrator computing device 12c are depicted as personal computers and the server computing device 12b is depicted as a server, these are non-limiting examples. More specifically, in some embodiments any type of computing device (e.g., mobile computing device, personal computer, server, etc.) may be utilized for any of these components. Additionally, while each of these computing devices is illustrated in FIG. 1 as a single piece of hardware, this is also merely an example. More specifically, each of the user computing device 12a, the server computing device 12b, and the administrator computing device 12c may represent a plurality of computers, servers, databases, etc.

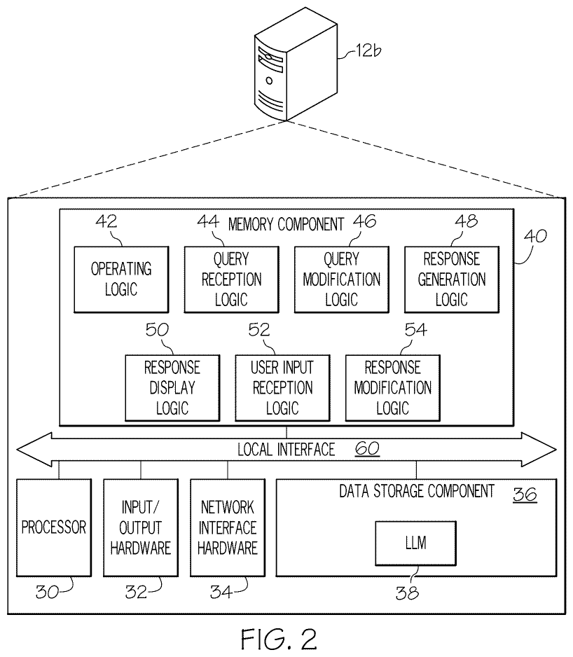

FIG. 2 depicts additional details regarding the server computing device 12b from FIG. 1. While in some embodiments, the server computing device 12b may be configured as a general purpose computer with the requisite hardware, software, and/or firmware, in other embodiments, the server computing device 12b may be configured as a special purpose computer designed specifically for performing the functionality described herein.

As also illustrated in FIG. 2, the server computing device 12b may include a processor 30, input/output hardware 32, network interface hardware 34, a data storage component 36 (which may store an LLM 38), and a non-transitory memory component 40. The memory component 40 may be configured as volatile and/or nonvolatile computer readable medium and, as such, may include random access memory (including SRAM, DRAM, and/or other types of random access memory), flash memory, registers, compact discs (CD), digital versatile discs (DVD), and/or other types of storage components. Additionally, the memory component 40 may be configured to store operating logic 42, query reception logic 44, query modification logic 46, response generation logic 48, response display logic 50, user input reception logic 52, and response modification logic 54 (each of which may be embodied as a computer program, firmware, or hardware, as an example). A local interface 60 is also included in FIG. 2 and may be implemented as a bus or other interface to facilitate communication among the components of the server computing device 12b.

The processor 30 may include any processing component configured to receive and execute instructions (such as from the data storage component 36 and/or memory component 40). The input/output hardware 32 may include a monitor, keyboard, mouse, printer, camera, microphone, speaker, touch-screen, and/or other device for receiving, sending, and/or presenting data. The network interface hardware 34 may include any wired or wireless networking hardware, such as a modem, LAN port, wireless fidelity (Wi-Fi) card, WiMax card, mobile communications hardware, and/or other hardware for communicating with other networks and/or devices.

It should be understood that the data storage component 36 may reside local to and/or remote from the server computing device 12b and may be configured to store one or more pieces of data for access by the server computing device 12b and/or other components. As illustrated in FIG. 2, the data storage component 36 may store an LLM, described in further detail below.

Included in the memory component 40 are the operating logic 42, the query reception logic 44, the query modification logic 46, the response generation logic 48, the response display logic 50, the user input reception logic 52, and the response modification logic 54. The operating logic 42 may include an operating system and/or other software for managing components of the server computing device 12b.

The query reception logic 44 may receive a query entered by a user into the user computing device 12a. The query entered by the user may define a question or problem seeking a solution. For example, a user generated query may be ‘clean laundry with less water’. However, it should be understood that a query specifying any type of question of problem may be input by the user. After the user inputs a query into the user computing device 12a, the query is transmitted to the server computing device 12b, where it is received by the query reception logic 44.

The query modification logic 46 modifies the query received by the query reception logic 44, as disclosed herein. In embodiments, disclosed herein, the query input by the user is modified by the query modification logic 46 before being input to an LLM. An LLM can receive queries and generate a response to the query. For example, if a query that includes a question or problem is input to an LLM, the LLM may generate an answer or solution to the query.

However, if a user generated query is input directly into an LLM, the LLM will typically generate a response that directly answers the query in a straight forward manner. While this may be useful for providing a solution to the user's question or problem, it may not stimulate the user to consider more varied or out-of-the box solutions that may come from other domains or from alternative ways of considering the problem. Accordingly, in embodiments, the query modification logic 46 modifies the query received by the query reception logic 44 to generate a modified query to cause the LLM to generate a plurality of responses, as disclosed herein.

In embodiments, the query modification logic 46 may generate a modified query to cause the LLM to generate a plurality of responses from a variety of domains that may encourage a user to consider a wider variety of solutions to the problem presented by the initial query. In one example, the query modification logic 46 may generate a query that instructs the LLM to provide solutions from several domains. For example, if the query reception logic 44 receives the query ‘clean laundry with less water’, the query modification logic 46 may generate a query comprising of ‘provide solutions to the problem of clean laundry with less water from multiple domains’. When people have only vague ideas of a solution, such as upon initially encountering stimuli of interests during ideation, they are likely to benefit from divergent thinking, which can be supported by providing them with not only relevant, but also semantically diverse stimuli. Analogical thinking can effectively uncover shared structural similarities of semantically diverse stimuli, that might be useful for supporting further exploration of stimuli of interest.

Analogical thinking may allow a user to transfer the functional mechanism or ‘active ingredient’ that solves a problem in one domain to another domain where it may also solve the problem. However, moving these functional mechanisms from a source domain to target domains may demand significant effort and expertise. Accordingly, in embodiments disclosed herein, this process is automated using artificial intelligence (AI), which may greatly assist users in obtaining solutions to a particular problem.

In one example, the query modification logic 46 may modify the received query to cause the LLM to generate diverse cross-domain applications of stimuli. The modified query may cause the LLM to generate application examples relative to the original problem domain to provide relevant yet semantically diverse information for supporting diverse thinking. In particular, the modified query may cause the LLM to generate example solutions to the received query in a plurality of problem domains. In some examples, the modified query may cause the LLM to generate example solutions in a hierarchical structure to provide multiple levels of concept abstraction and offer a clear, organized view. In one example, more abstract concepts may be placed at higher levels of the hierarchical structure and more concrete concepts may be placed at lower levels of the hierarchical structure.

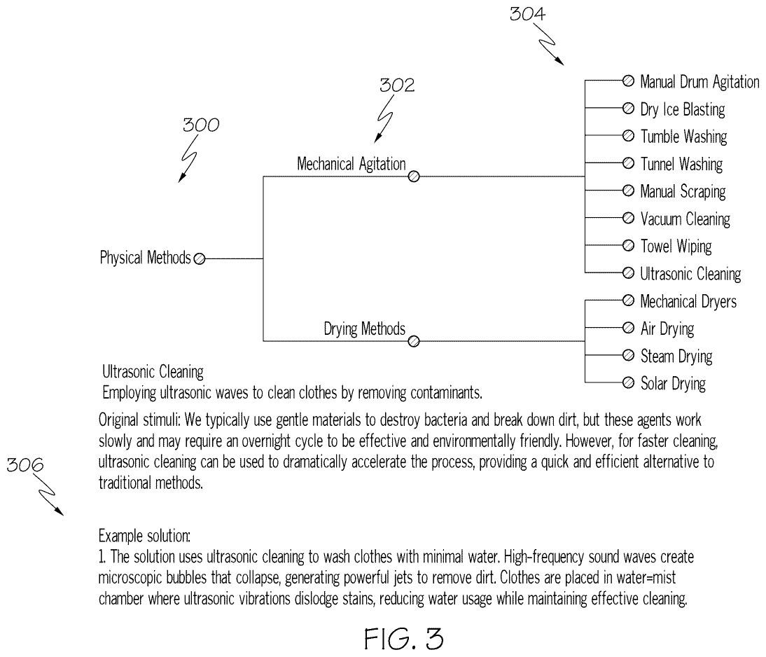

FIG. 3 shows an example hierarchical structure of example solutions to the query of reducing an amount of water used in laundry. A first hierarchical level 300 includes physical methods and material technologies as categories of solutions. A second hierarchical level 302 shows mechanical agitation and drying methods as different physical methods. A third hierarchical level 304 shows a plurality of example solutions under mechanical agitation including manual drum agitation, dry ice blasting, tumble washing, tunnel washing, manual scraping, vacuum cleaning, towel wiping, ultrasonic cleaning, mechanical dryers, air drying, steam drying, and solar drying. In embodiments, the query modification logic 46 may generate a modified query to cause the LLM to generate such example solutions.

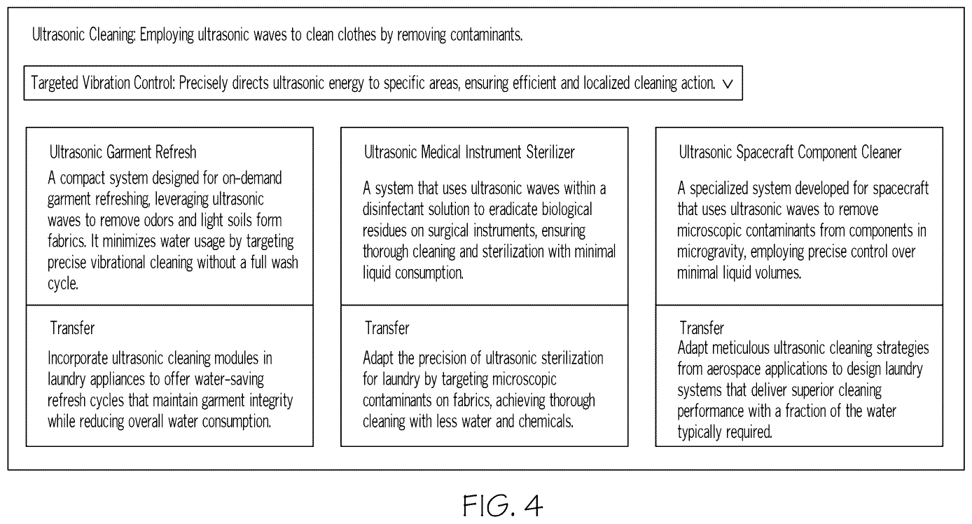

In some examples, for each example solution, the modified query may cause the LLM to extract core functional mechanisms, or ‘active ingredients’ from the solution. The modified query may then cause LLM to generate example solutions in a variety of domains with a similar core functional mechanism. FIG. 4 shows a list view of three such example solutions related to ultrasonic cleaning: ultrasonic garment refresh, ultrasonic medical instrument sterilizer, and ultrasonic spacecraft component cleaner. The three examples of FIG. 4 come from different domains but share the principle of ‘target vibration control’ when adopting ‘ultrasonic cleaning’.

The modified query generated by the query modification logic 46 may also cause the LLM to generate actionable transfer strategies for adaptation of the example solutions. In particular, a transfer strategy may indicate how an example solution in a different domain may be applied to the problem included in the query. For example, a medical instrument sterilizer might suggest a transfer such as “adapt the precision of ultrasonic sterilization for laundry by targeting microscopic contaminants on fabrics, achieving thorough cleaning with less water and chemicals”.

Referring back to FIG. 2, the response generation logic 48 may input the modified query generated by the query modification logic 46 into the LLM 38 to generate a response to the modified query. Any type of LLM may be used as the LLM 38 stored in the data storage component 36.

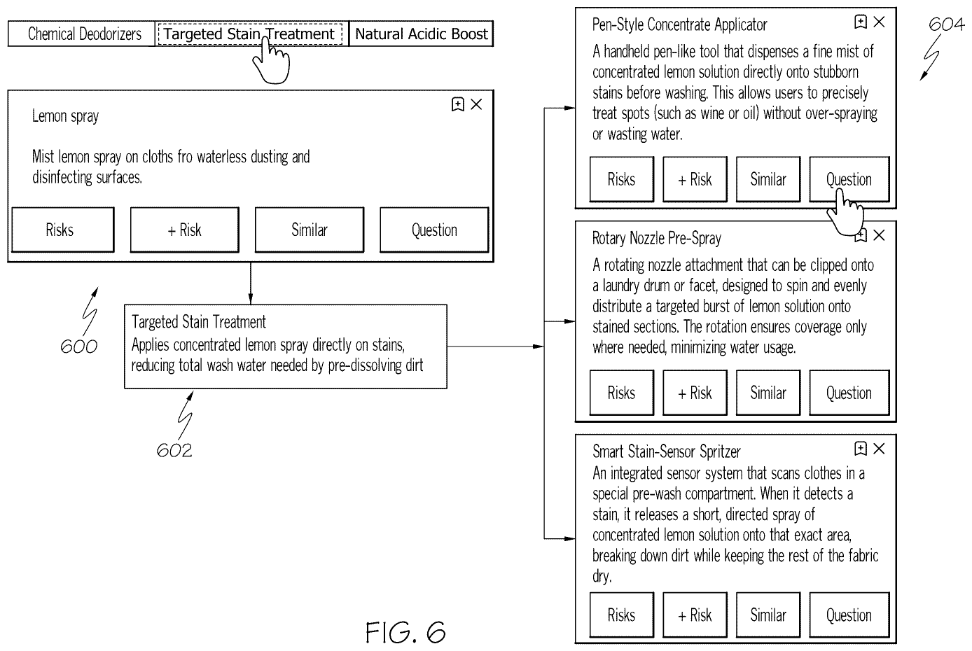

Referring to FIG. 2 in conjunction with FIG. 1, the response display logic 50 may cause the user computing device 12a to display the response generated by the LLM in response to the input of the modified query by the response generation logic 48. In some examples, the response display logic 50 may cause the user computing device 12a to display the response generated by the LLM in a list view, as shown in FIG. 4. In some examples, the response display logic 50 may cause the user computing device 12a to display the response generated by the LLM in a hierarchical structure, as shown in FIG. 3, or as shown in FIGS. 6-10, as discussed in further detail below. In other examples, the response display logic 50 may cause the user computing device 12a to display the response generated by the LLM in other manners.

Referring back to FIG. 2, the user input reception logic 52 may receive user input of a user interacting with the displayed response. For example, the user may click on certain portions of the response to generate additional information. In the example of FIG. 3, the user may click on a particular solution in the third hierarchical level 304 to receive additional information. In response to the user clicking, the response modification logic 54 may generate a new query to be input to the LLM to cause the LLM to generate additional data based on what the user clicked. The response modification logic 54 may then input the new query to the LLM, and modify the response displayed to the user based on output of the LLM, as discussed in further detail below.

Referring back to FIG. 2, as discussed above, the response modification logic 54 may modify the displayed information based on the user input received by the user input reception logic 52. The response modification logic 54 may modify the displayed information in a variety of different manners. In the example shown in FIG. 3, if the user clicks on a particular solution, the response modification logic 54 may input a query to the LLM requesting a transfer strategy for applying the selected solution to the original query, and then display the transfer strategy associated with the selected solution generated by the LLM. In the example of FIG. 3, the transfer strategy 306 for ultrasonic cleaning is shown.

As discussed above, in some examples, when user input is received by the user input reception logic 52, the response modification logic 54 may generate a new query and input the new query to the LLM 38 to receive additional information. For example, if the user selects a particular solution, the response modification logic 54 may generate a new query to receive additional information from the LLM 38 about this solution. However, when a new query is input to the LLM 38, the context from previous queries may be maintained such that generated responses are consistent with each other.

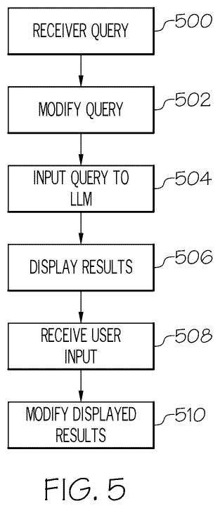

FIG. 5 shows a flowchart of an example method that may be performed by the server computing device 12b to implement a system for creative ideation. Although the steps associated with the steps of FIG. 5 will be described as being separate tasks, in other embodiments, the blocks may be combined or omitted.

At step 500, the query reception logic 44 (See FIG. 2) receives a query input by a user. As discussed above, a user may input a query comprising a question or problem into the user computing device 12a. This query may be transmitted to the server computing device 12b, and received by the server computing device 12b.

At step 502, the query modification logic 46 (See FIG. 2) modifies the query received by the query reception logic 44, as discussed above. In particular, the query modification logic 46 may modify the query such that, when input to the LLM 38, the modified query causes the LLM 38 to output a plurality of solutions associated with the query.

At step 504, the response generation logic 48 (See FIG. 2) inputs the modified query to LLM 38. The LLM 38 then outputs a plurality of results or solutions associated with the modified query. At step 506, the response display logic 50 (See FIG. 2) causes the user computing device 12a to display the results output by the LLM 38. In some examples, the response display logic 50 may cause the user computing device 12a to display the results in a hierarchical structure, as discussed above.

At step 508, the user input reception logic 52 (See FIG. 2) receive user input from the user after displaying the results output by the LLM 38. For example, the user may interact with the displayed results to generate the user input. At step 510 (See FIG. 2), the response modification logic 54 modifies the displayed results based on the received user input. In some examples, in response to receiving the user input, the response modification logic 54 generates a new query based on the user input, submits the new query to the LLM 38, and displays information to the user based on the output of the LLM 38. In some examples, the user input may request tradeoffs associated with a solution, and the response modification logic 54 may cause the LLM to output tradeoffs to the solution. These tradeoffs may be displayed to the user, and the user may then request solutions to one or more of the tradeoffs. The response modification logic 54 may then cause the LLM to output solutions to a selected tradeoff and may output these solutions. This may be continued indefinitely, with the displaying of tradeoffs to solutions, and solutions to tradeoffs as the user continues to request additional information. An example workflow is discussed further below.

FIG. 6 shows an example display that may be generated by the response generation logic 48 (See FIG. 2). In the example of FIG. 6, the query reception logic 44 (See FIG. 2) receives a query of ‘how to clean laundry with less water’. The query modification logic 46 then modifies the query to generate a modified query to be input to the LLM 38. The response generation logic 48 then inputs the modified query to the LLM 38, and the response display logic 50 may display the results output by the LLM 38 as shown in FIG. 6.

In the example of FIG. 6, the LLM 38 outputs the solutions chemical deodorizers, targeted stain treatment, and natural acidic boost, which are displayed to the user. The user may then click on one of these solutions to receive additional information. In the example of FIG. 6, the user clicks on target stain treatment, and the solution lemon spray is displayed, along with the instructions “Mist lemon spray on cloths for waterless dusting and disinfecting surfaces” in section 600. In addition, underneath these instructions, are additional buttons “Risk”, “+Risk”, “Similar”, and “Question”. The user can click on each of these buttons to generate additional information.

The button “Risk” allows the user to see risks associated with this solution. The button “+Risk” allows the user to add risks to the solution. The button “Similar” allows the user to see similar solutions, and the button “Question” allows the user to ask a question about the solution. When the user clicks one of these buttons, the user input reception logic 52 (See FIG. 2) receives an indication as to which button the user clicked. The response modification logic 54 (See FIG. 2) then inputs a new query to the LLM 38 to receive the requested information, while maintaining the context of previous queries.

In the example of FIG. 6, the user clicks the “Similar” button under the solution targeted stain treatment and the instructions “Applies concentrated lemon spray directly on stains, reducing total wash water needed by pre-dissolving dirt” is shown in section 602. The, additional solutions are shown in section 604. In particular, the additional solutions “Pen-Style Concentrate Applicator”, “Rotary Nozzle Pre-Spray”, and “Smart Stain-Sensor Spritzer” are shown. Each of these solutions allows the user to click on “Risk”, “+Risk”, “Similar”, and “Question”. The user may click on any of these buttons to get additional information about any of these solutions. This process may be repeatedly continually, with additional information being generated by the LLM 38 and displayed to the user.

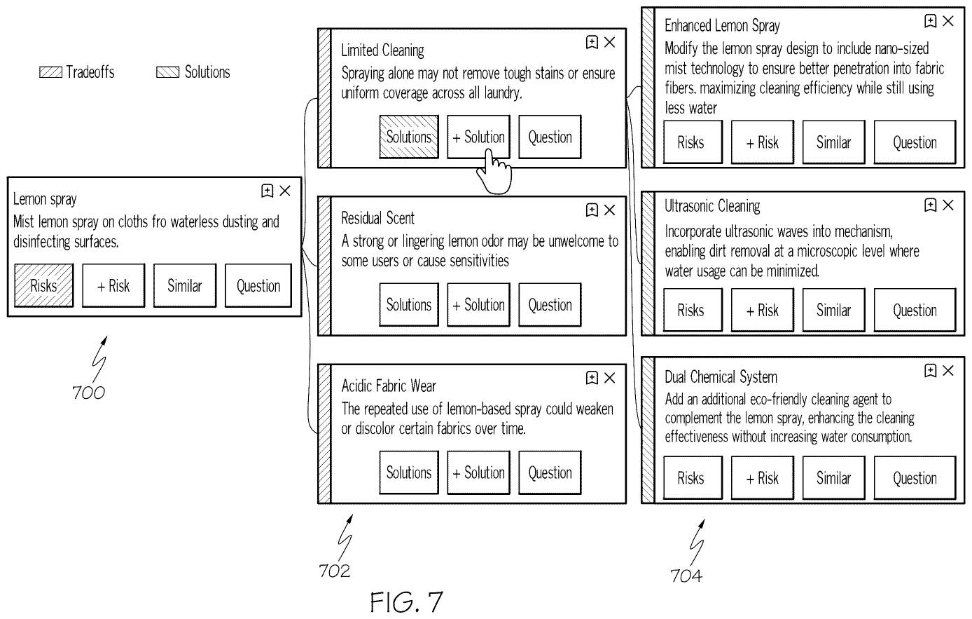

FIG. 7 shows another example of a response that may be provided to the query of ‘how to clean laundry with less water’. Section 700 shows the solution Lemon spray, in a similar manner as shown in FIG. 6. However, in the example of FIG. 7, the user clicks the button “Risks”. This causes the response modification logic 54 (See FIG. 2) to input an additional query to the LLM 38 to generate risks associated with this solution. The LLM generates the risks “Limited Cleaning”, “Residual Scent”, and “Acidic Fabric Wear”, which are displayed in section 702. Under each of these risks, the buttons “Solutions”, “+Solution” and “Question” are shown. Clicking on the “Solutions” buttons generates solutions to the risk. Clicking on the “+Solution” button allows the user to add a risk. Clicking on the “Question” button allows the user to ask a question about the risks.

In the example of FIG. 7, the user clicks the “Solutions” button under Limited Cleaning, which causes the response modification logic 54 (See FIG. 2) to input an additional query to the LLM 38 to generate solutions to this risk of Limited Cleaning. The LLM 38 then generates the solutions “Enhanced Lemon Spray”, “Ultrasonic Cleaning”, and “Dual Chemical System”, which are displayed to the user in section 704, along with an explanation of each solution. The user may then click on the buttons associated with any of these solutions to continue to seek more information.

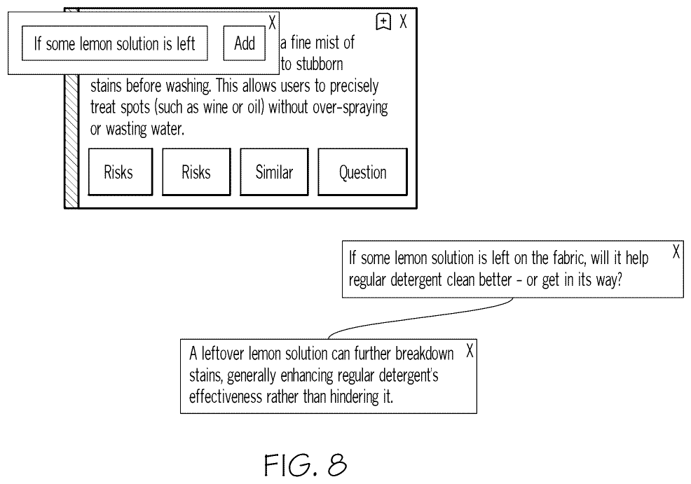

FIG. 8 shows an example of when the user clicks on the “Question” button underneath “Pen-Style Concentrate Applicator” in the example of FIG. 6. In the example of FIG. 8, the user inputs the question “If some lemon solution is left on the fabric, will it help regular detergent clean better—or get in the way”. The response generation logic 48 (See FIG. 2) then inputs a modified query into the LLM 38 to receive a response to this question while maintaining the context of previous interactions with the LLM 38. In the example of FIG. 8, the LLM 38 generates the answer “A leftover lemon solution can further break down stains, generally enhancing regular detergent's effectiveness rather than hindering it”. This allows the user to ask specific questions about presented solutions.

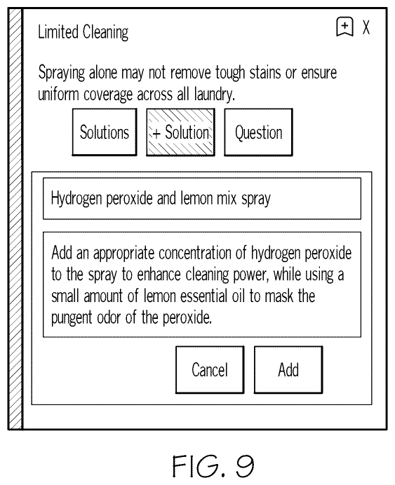

FIG. 9 shows an example of when the user clicks the “+Solution” button underneath “Limited Cleaning” in section 702 of FIG. 7. In the example of FIG. 9, the user enters “Hydrogen peroxide and lemon mix spray” as a proposed solution into a text box. The response modification logic 54 (See FIG. 2) then inputs a new query into the LLM 38 with this proposed solution. The LLM 38 may then generate instructions for this proposed solution using the previous context, which is displayed as shown in FIG. 9. This allows a user to propose their own solutions and receive additional feedback about such proposed solutions.

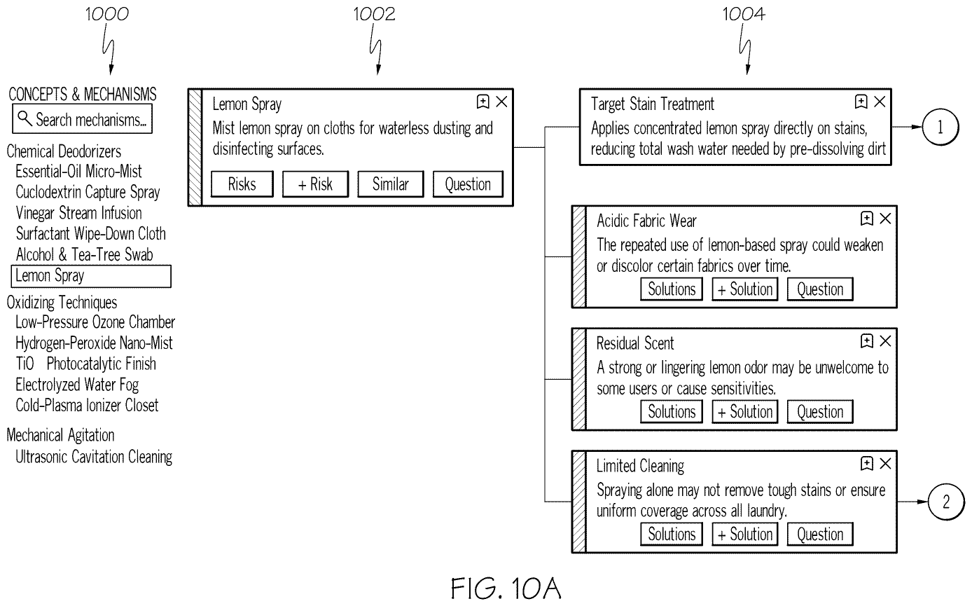

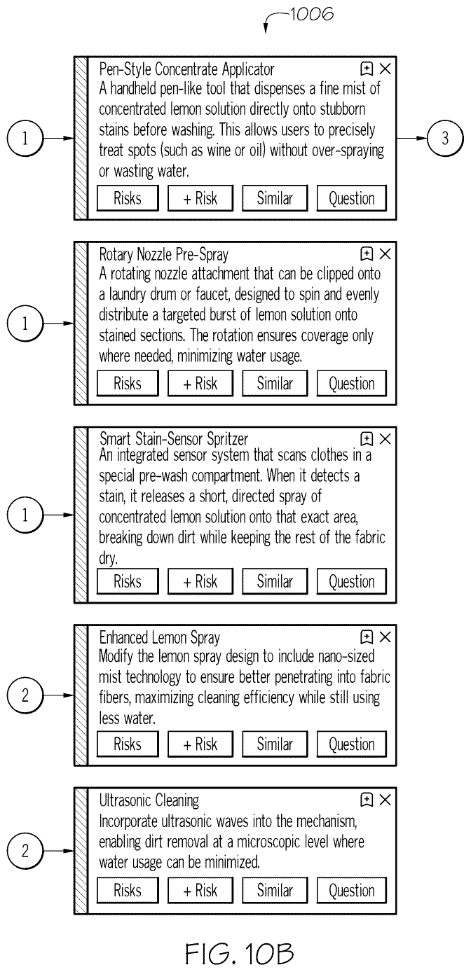

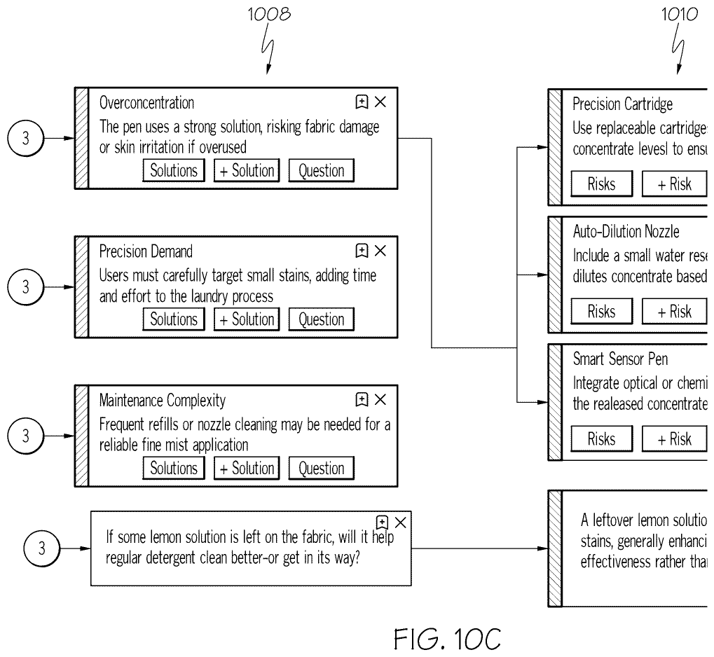

FIGS. 10A-10C show another example display that may be generated by the server computing device 12b (See FIG. 2) in response to the query ‘how to clean laundry with less water’. The displays shown in FIGS. 10A-10C may combined into a single display when presented to the user. In the example of FIGS. 10A-10C, proposed categories including “Chemical Deodorizers”, “Oxidizing Techniques”, and “Mechanical Agitation” are shown in section 1000 of FIG. 10A. A plurality of solutions for each category may be presented.

In the example of FIG. 10A, the user selects “Lemon spray”, which is displayed in section 1002 along with instructions and four buttons for receiving additional information. Section 1004 of FIG. 10A then shows risks associated with the solution “Lemon spray”. Section 1006 of FIG. 10B shows solutions to certain of the risks displayed in section 1004 of FIG. 10A. Section 1008 of FIG. 10C shows risks associated with certain of the solutions displayed in section 1006 of FIG. 10B. Section 1010 of FIG. 10C shows solutions to certain of the displayed in section 1008 of FIG. 10C. As such, the user may click on different interface buttons associated with risks or solutions to continually generate additional risks associated with solutions or solutions associated with risks. These solutions and risks may be displayed in a hierarchical manner.

It should now be understood that embodiments described herein are directed to methods for creative ideation through structuring inspiration. By presenting potential solutions to a problem from a variety of different domains, they may allow a user to come up with more creative solutions to problems. Displaying solutions in a hierarchical structure may allow for a user to more easily discover relevant information for a particular problem. In particular, analogical cues, such as diverse application examples and extracted functional components, may be helpful in allowing a user to adapt and repurpose ideas. This may inspire new ways for a user to integrate different solutions into their own problem spaces.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A method comprising:
receiving a query;
modifying the query to generate a modified query to be input into a large language model to cause the large language model to output a plurality of solutions associated with the query;
inputting the modified query to the large language model; and
displaying an output of the large language model in response to the modified query in a hierarchical structure.

2. The method of claim 1, wherein the modified query causes the large language model to output the plurality of solutions from different problem domains.

3. The method of claim 1, wherein the modified query causes the large language model to output the plurality of solutions having similar core functional mechanisms.

4. The method of claim 1, wherein the hierarchical structure displays more abstract concepts at a higher hierarchical level and displays more concrete concepts at a lower hierarchical level.

5. The method of claim 1, further comprising:
receiving a user input associated with the displayed output;
generating an additional query based on the user input;
inputting the additional query into the large language model; and
displaying an output of the large language model in response to the additional query.

6. The method of claim 5, wherein:
the user input comprises selection of a first solution among the plurality of solutions; and
the output of the large language model in response to the additional query comprises a transfer strategy for transferring the first solution to a problem associated with the query.

7. The method of claim 5, wherein:
the user input comprises a request for risks associated with a first solution among the plurality of solutions; and
the output of the large language model in response to the additional query comprises one or more risks associated with the first solution.

8. The method of claim 7, further comprising:
receiving a second user input comprises a request for solutions to a first risk associated with the one or more risks;
generating a second additional query based on the second user input;
inputting the second additional query to the large language model; and
displaying an output of the large language model in response to the second additional query.

9. The method of claim 5, wherein:
the user input comprises a user submitted question about a first solution among the plurality of solutions; and
the output of the large language model in response to the user input comprises an answer to the user submitted question.

10. The method of claim 5, wherein:
the user input comprises a request for similar solutions to a first solution among the plurality of solutions; and
the output of the large language model in response to the user input comprises a second plurality of solutions similar to the first solution.

11. A computing device comprising one or more processors configured to:
receive a query;
modify the query to generate a modified query to be input into a large language model to cause the large language model to output a plurality of solutions associated with the query;
input the modified query to the large language model; and
display an output of the large language model in response to the modified query in a hierarchical structure.

12. The computing device of claim 11, wherein the modified query causes the large language model to output the plurality of solutions from different problem domains.

13. The computing device of claim 11, wherein the modified query causes the large language model to output the plurality of solutions having similar core functional mechanisms.

14. The computing device of claim 11, wherein the hierarchical structure displays more abstract concepts at a higher hierarchical level and displays more concrete concepts at a lower hierarchical level.

15. The computing device of claim 11, wherein the one or more processors are further configured to:
receive a user input associated with the displayed output;
generate an additional query based on the user input;
input the additional query into the large language model; and
display an output of the large language model in response to the additional query.

16. The computing device of claim 15, wherein:
the user input comprises selection of a first solution among the plurality of solutions; and
the output of the large language model in response to the additional query comprises a transfer strategy for transferring the first solution to a problem associated with the query.

17. The computing device of claim 15, wherein:
the user input comprises a request for risks associated with a first solution among the plurality of solutions; and
the output of the large language model in response to the additional query comprises one or more risks associated with the first solution.

18. The computing device of claim 17, wherein the one or more processors are further configured to:
receive a second user input comprises a request for solutions to a first risk associated with the one or more risks;
generate a second additional query based on the second user input;
input the second additional query to the large language model; and
display an output of the large language model in response to the second additional query.

19. The computing device of claim 15, wherein:
the user input comprises a user submitted question about a first solution among the plurality of solutions; and
the output of the large language model in response to the user input comprises an answer to the user submitted question.

20. The computing device of claim 15, wherein:
the user input comprises a request for similar solutions to a first solution among the plurality of solutions; and
the output of the large language model in response to the user input comprises a second plurality of solutions similar to the first solution.
